(19) United States
(12) Patent Application Publication
(10) Pub. No.: US 2012/0238222 A1
(43) Pub. Date: Sep. 20, 2012

(54) RADIO APPARATUS MOUNTED ON A VIECLE

(75) Inventors: Ken NAKAOKA, Ichinomiya City (JP); Makoto Nagai, Kakamigahara City (JP)

(73) Assignee: SANYO ELECTRIC CO., LTD., Osaka (JP)

(21) Appl. No.: 13/425,168

(22) Filed: Mar. 20, 2012

Related U.S. Application Data
(63) Continuation of application No. PCT/JP2010/066499, filed on Sep. 24, 2010.

(30) Foreign Application Priority Data
Sep. 25, 2009 (JP) 2009-221421
Sep. 22, 2010 (JP) 2010-211671

(51) Int. Cl. H04W 88/02

(52) U.S. Cl. 455/90.1

(57) ABSTRACT

A radio unit transmits a packet signal. An acquiring unit acquires information about a traveling status of a vehicle. When the acquired information indicates a stop of the vehicle, an instructing unit allows the radio unit to stop transmitting the packet signal. A position detecting unit detects, based on positional information of the vehicle, whether the vehicle is present in a predetermined area. If the position detecting unit detects presence, the instructing unit allows the radio unit to continue transmitting the packet signal even when the information acquired by the acquiring unit indicates the stop of the vehicle.

### BACKGROUND OF THE INVENTION

1. Field of the Invention

The present invention relates to communication technology and specifically relates to a radio apparatus mounted on a vehicle.

2. Description of the Related Art

An intelligent transport systems (ITS) inter-vehicle communication system notifies a position and speed information of its own vehicle to another vehicle out of sight as one of applications. By this notification, it is expected to prevent collision accident of vehicles at a blind intersection and the like. By increase in the number of vehicles on which a terminal apparatus supporting such ITS inter-vehicle communication system is mounted, interference increases and cross talk increases.

Also, a status of the interference and the cross talk differs according to a communication condition and a communication environment. In order to respond to this, it is controlled to decrease transmission power when difference between a speed of the vehicle on which the terminal apparatus to be communicated with is mounted and the speed of its own vehicle decreases and to increase the transmission power when the difference increases.

An access control function referred to as carrier sense multiple access with collision avoidance (CSMA/CA) is used in a wireless local area network (LAN), which meets standards such as IEEE802.11. Therefore, the same radio channel is shared by a plurality of terminal apparatuses in the wireless LAN. On the other hand, when the wireless LAN of which wireless channel is shared is applied to the ITS inter-vehicle communication system, it is required to transmit information to a large indefinite number of terminal apparatuses, so that it is desired that a signal is broadcast-transmitted. In broadcast transmission, the terminal apparatus to be communicated with is not specified, so that the control based on the difference between the speed of the vehicle on which the terminal apparatus to be communicated with is mounted and the speed of its own vehicle becomes difficult. Also, by increase in traffic due to increase in the number of vehicles, that is to say, the increase in the number of terminal apparatuses, it is supposed that signal collision increases. As a result, the information included in the signal is not transmitted to another terminal apparatus. When such a state occurs in the ITS inter-vehicle communication, an object to prevent the collision accident is not achieved.

### SUMMARY OF THE INVENTION

The present invention is achieved in view of such circumstances and an object thereof is to provide the technology to decrease the collision probability of the signals.

In order to solve the above-described problem, a radio apparatus according to an aspect of the present invention is the radio apparatus mounted on a vehicle provided with a transmitting unit that transmits a packet signal, an acquiring unit that acquires information about a traveling status of a vehicle, and an instructing unit that allows the transmitting unit to stop transmitting the packet signal when the information acquired by the acquiring unit indicates a stop of the vehicle.

Meanwhile, optional combination of the above-described components and those obtained by converting representation of the present invention among a method, an apparatus, a system, a recording medium, and a computer program also are effective as an aspect of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view illustrating a configuration of a communication system according to an embodiment of the present invention;

FIG. 2 is a view illustrating a configuration of a radio apparatus mounted on a vehicle 1 in FIG. 1;

FIG. 3 is a flowchart illustrating a procedure of a transmission process by the radio apparatus in FIG. 2;

FIG. 4 is a view illustrating the configuration of the radio apparatus according to a modification of the present invention;

FIG. 5 is a flowchart illustrating the procedure of the transmission process by the radio apparatus in FIG. 4;

FIG. 6 is a view illustrating the configuration of the radio apparatus according to another modification of the present invention;

FIG. 7 is a flowchart illustrating the procedure of the transmission process by the radio apparatus in FIG. 6;

FIG. 8 is a view illustrating the configuration of the radio apparatus according to still another modification of the present invention; and

FIG. 9 is a flowchart illustrating the procedure of the transmission process by the radio apparatus in FIG. 8.

### DETAILED DESCRIPTION OF THE INVENTION

The invention will now be described by reference to the preferred embodiments. This does not intend to limit the scope of the present invention, but to exemplify the invention.

Before specifically describing the present invention, we describe an outline thereof. An embodiment of the present invention relates to a communication system, which executes data communication between radio apparatuses mounted on vehicles. The radio apparatus transmits a packet signal in which information such as a speed and a position of the vehicle (hereinafter, they are referred to as “data”) is stored (hereinafter, the packet signal in which the data is stored is sometimes referred to as the “data”). In addition, the radio apparatus receives the packet signal transmitted by another radio apparatus and recognizes approach of another vehicle on which the other radio apparatus is mounted based on the data. Herein, in order to allow a plurality of radio apparatuses to efficiently receive the data, broadcast transmission is performed as transmission. As described above, collision probability of the packet signals increases as the number of radio apparatuses increases, so that decrease in the collision probability is desired. In order to respond to this, the communication system according to this embodiment executes the following process.

The radio apparatus according to this embodiment acquires information about a traveling status of the vehicle. The information about the traveling status of the vehicle indicates whether the vehicle travels or stops, for example. When the vehicle travels, the radio apparatus transmits the packet signal. On the other hand, when the vehicle stops, the radio apparatus stops transmitting the packet signal. An example of a stop of the vehicle is a case in which the vehicle is parked. The data transmitted in such case is not necessarily required to inhibit a collision accident. Therefore, this embodiment inhibits increase in traffic by stopping the transmission in a case in which the vehicle stops, thereby decreasing the collision probability of the packet signals. On the other hand, another example of the stop of the vehicle is a case in which the vehicle stops following a red traffic signal at an intersection and the like. The vehicle is about to enter the intersection and the like, so that the data transmitted in such case is required for inhibiting the collision accident. Therefore, the radio apparatus continues transmitting the packet signal even in a stopping state if this stops following the red traffic signal.

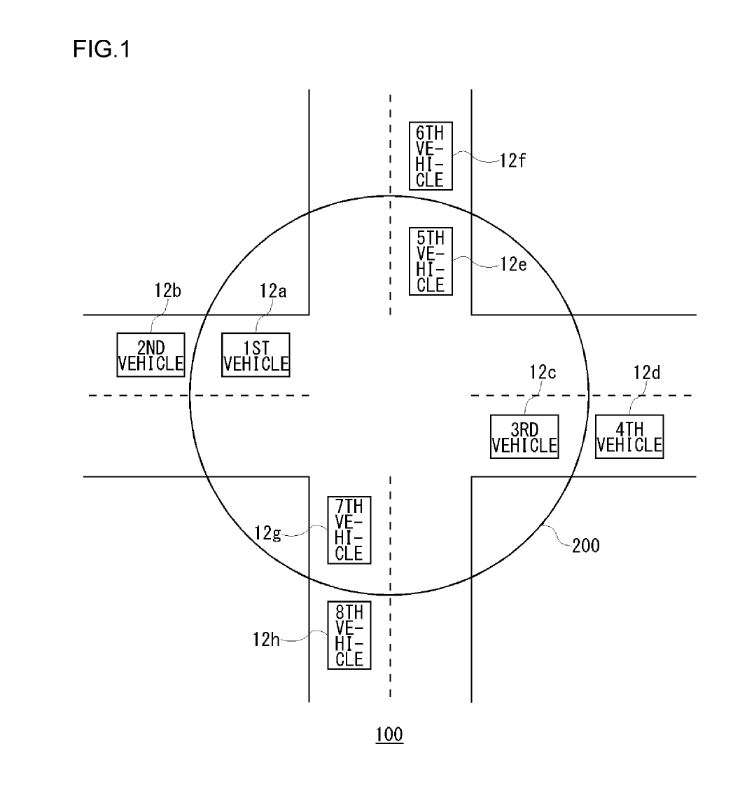

FIG. 1 illustrates a configuration of a communication system 100 according to the embodiment of the present invention. This corresponds to a case in which one intersection is seen from above. The communication system 100 includes a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h, which are collectively referred to as vehicles 12. Also, an area 200 around the intersection is defined. Meanwhile, the radio apparatus not illustrated is mounted on each vehicle 12.

As illustrated, a road in a horizontal direction, that is to say, in a right-left direction of the drawing and a road in a vertical direction, that is to say, in an up-down direction of the drawing intersect with each other on a central portion. Herein, an upper side of the drawing corresponds to the “north”, a left side thereof corresponds to the “west”, a lower side thereof corresponds to the “south”, and a right side thereof corresponds to the “east”. Also, a portion at which the two roads intersect with each other is the “intersection”. The first and second vehicles 12a and 12b travel from left to right and the third and fourth vehicles 12c and 12d travel from right to left. Also, the fifth and sixth vehicles 12e and 12f travel from above downward and the seventh and eighth vehicles 12g and 12h travel from below upward.

The radio apparatus mounted on each vehicle 12 acquires the above-described data and broadcast-transmits the packet signal in which the data is stored. Herein, each radio apparatus supports CSMA/CA as a widely-known wireless LAN and broadcast-transmits the data when this executes carrier sense and determines that the transmission is possible. Further, each radio apparatus receives the data from another radio apparatus and notifies a driver of the approach of the vehicle 12 on which another radio apparatus is mounted. When the vehicle 12 stops, the radio apparatus stops transmitting the data. In this case, the radio apparatus supposes that the vehicle 12 is parked. As a result, unnecessary transmission of the data is inhibited, and according to this, a traffic amount is decreased. On the other hand, when a stopping position of the vehicle 12 is in the area 200, the radio apparatus does not stop transmitting the data and continues transmitting the data. The area 200 is set in the vicinity of the intersection and in the vicinity of a traffic signal, for example. That is to say, the area 200 is set in an area in which the vehicle 12 is not parked but this might stop. Herein, the area 200 is defined in advance on map data held by the radio apparatus.

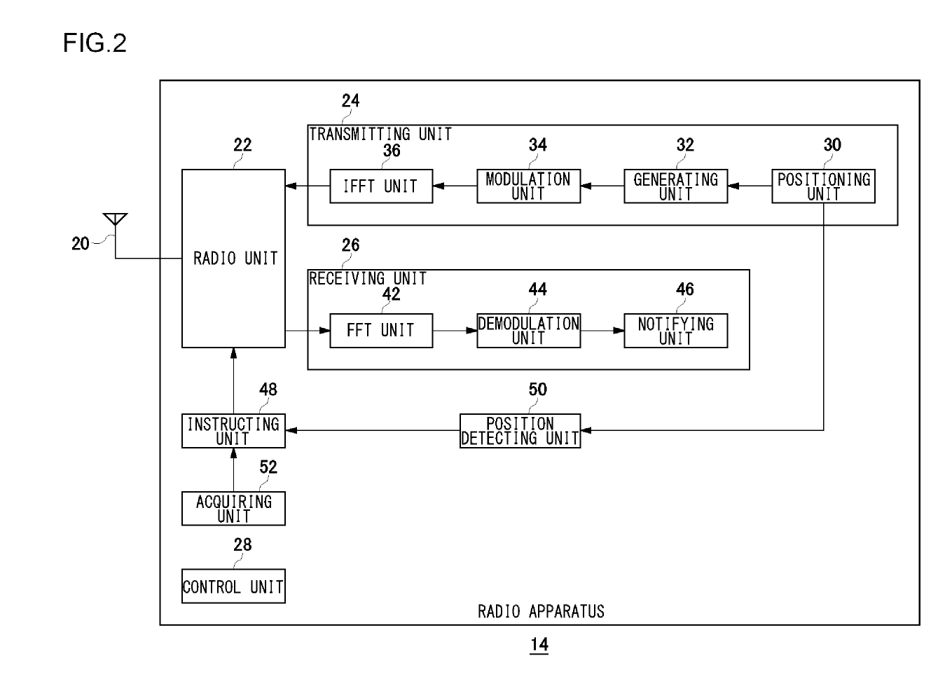

FIG. 2 illustrates a configuration of a radio apparatus 14 mounted on the vehicle 12. The radio apparatus 14 includes an antenna 20, a radio unit 22, a transmitting unit 24, a receiving unit 26, a control unit 28, an instructing unit 48, a position detecting unit 50, and an acquiring unit 52. The transmitting unit 24 includes a positioning unit 30, a generating unit 32, a modulation unit 34, and an IFFT unit 36. Also, the receiving unit 26 includes a FFT unit 42, a demodulation unit 44, and a notifying unit 46.

The positioning unit 30 includes a global positioning system (GPS) receiver, a gyroscope, a vehicle speed sensor and the like, for acquiring a position of the vehicle 12 on which the radio apparatus 14 is mounted, a travel direction, a moving speed and the like of the vehicle. Meanwhile, the position of presence is indicated by latitude and longitude. The widely-known technology may be used for acquiring the position of presence and the like by the positioning unit 30, so that the description thereof is herein omitted. The positioning unit 30 outputs information about the position of the vehicle 12 (hereinafter, also referred to as “positional information”), that is to say, the above-described data to the generating unit 32.

The generating unit 32 acquires the data from the positioning unit 30. The generating unit 32 generates the packet signal so as to store the data. The packet signal also includes information for identifying this radio apparatus 14. The generating unit 32 outputs the generated packet signal to the modulation unit 34. The modulation unit 34 modulates the packet signal from the generating unit 32. As a modulation method, BPSK, QPSK, 16QAM, 64QAM and the like are defined. Also, the modulation unit 34 outputs a modulated result to the IFFT unit 36 as a baseband packet signal. Meanwhile, the baseband packet signal corresponds to an OFDM signal in a frequency domain. In general, the baseband packet signal is formed of an in-phase component and a quadrature component, so that two signal lines should be indicated; however, only one signal line is herein indicated for making the drawing clear.

The IFFT unit 36 inputs the baseband packet signal from the modulation unit 34. The IFFT unit 36 executes inverse fast Fourier transform (IFFT), thereby transforming the OFDM signal in the frequency domain to the OFDM signal in a time domain. Meanwhile, the OFDM signal in the time domain also is referred to as the baseband packet signal. The radio unit 22 executes frequency transform on the baseband packet signal input from the IFFT unit 36 to generate the packet signal at a radio frequency for a transmission process. Further, the radio unit 22 broadcast-transmits the packet signal at the radio frequency from the antenna 20. Meanwhile, the radio unit 22 also includes a power amplifier (PA), a mixer, and a D/A converting unit. As described above, the transmission of the packet signal is performed according to an access control function referred to as the CSMA/CA as the wireless LAN, which meets standards such as IEEE802.11.

The radio unit 22 receives the packet signal broadcast-transmitted from another radio apparatus 14 not illustrated by means of the antenna 20 for a reception process. Another radio apparatus 14 is mounted on another vehicle 12 not illustrated. The radio unit 22 executes the frequency transform on the packet signal at the radio frequency received by means of the antenna 20 to generate the baseband packet signal. Herein, the baseband packet signal is the OFDM signal in the time domain. Further, the radio unit 22 outputs the baseband packet signal to the FFT unit 42. The radio unit 22 also includes a low noise amplifier (LNA), the mixer, an AGC, and an A/D converting unit.

The FFT unit 42 inputs the OFDM signal in the time domain from the radio unit 22. The FFT unit 42 executes FFT on the OFDM signal in the time domain, thereby transforming the OFDM signal in the time domain to the OFDM signal in the frequency domain. The OFDM signal in the frequency domain is formed of a plurality of subcarrier signals. Further, the FFT unit 42 outputs the OFDM signal in the frequency domain to the demodulation unit 44. The demodulation unit 44 accepts the OFDM signal in the frequency domain from the FFT unit 42. The demodulation unit 44 demodulates the OFDM signal in the frequency domain. As described above, since the OFDM signal in the frequency domain is formed of a plurality of subcarrier signals, the demodulation unit 44 executes a demodulation process to each of a plurality of subcarrier signals. The demodulation unit 44 outputs a demodulated result to the notifying unit 46.

The notifying unit 46 accepts the demodulated result from the demodulation unit 44. The notifying unit 46 acquires the information about the position of another vehicle included in the packet signal by processing the demodulated result. The notifying unit 46 detects the position of presence, the approach and the like of another vehicle 12 based on the information about the position of another vehicle. At that time, the notifying unit 46 may accept the information about the position of its own vehicle from the positioning unit 30. Also, the notifying unit 46 notifies the driver of the approach and the like by means of a monitor and a speaker not illustrated. By recognition of the approach of another vehicle by the driver, the collision accident is prevented. Meanwhile, when the approach of another vehicle is notified by means of the monitor, the notifying unit 46 may superimpose an image of another vehicle on a map image displayed by a car navigation apparatus.

The acquiring unit 52 acquires the information about the traveling status of the vehicle 12 on which this radio apparatus 14 is mounted. Herein, the information about the traveling status of the vehicle 12 corresponds to whether the vehicle 12 travels or stops. The acquiring unit 52 is connected to a speed sensor of the vehicle 12 not illustrated and accepts a value of the moving speed from the speed sensor. The acquiring unit 52 sets a threshold in advance and determines that the vehicle 12 stops when the moving speed is lower than the threshold. On the other hand, it is determined that the vehicle 12 travels when the moving speed is not lower than the threshold. Meanwhile, the acquiring unit 52 may determine whether the vehicle 12 travels or stops by deriving the moving speed based on change with time of the positional information accepted from the positioning unit 30. The acquiring unit 52 outputs the information about whether the vehicle 12 travels or stops to the instructing unit 48.

The position detecting unit 50 accepts the positional information of the vehicle 12 on which this radio apparatus 14 is mounted from the positioning unit 30. Further, the position detecting unit 50 holds the map data and the positional information of the area 200 is included in the map data. Meanwhile, the area 200 may be defined so as to correspond to a plurality of sites. Also, the map data may be held by a navigation apparatus not illustrated and the position detecting unit 50 may hold the positional information of the area 200. The position detecting unit 50 compares the positional information of the area 200 with the positional information of the vehicle 12, thereby detecting whether the vehicle 12 is present in any of the areas 200. The position detecting unit 50 outputs information about whether the vehicle 12 is present in any of the areas 200 to the instructing unit 48.

The instructing unit 48 accepts the information about whether the vehicle 12 travels or stops from the acquiring unit 52 and accepts the information about whether the vehicle 12 is present in any of the areas 200 from the position detecting unit 50. The instructing unit 48 allows the radio unit 22 to continue transmitting the packet signal when the information about whether the vehicle 12 travels or stops indicates a travel of the vehicle 12. On the other hand, the instructing unit 48 allows the radio unit 22 to stop transmitting the packet signal when the information about whether the vehicle 12 travels or stops indicates the stop of the vehicle 12. Meanwhile, the instructing unit 48 allows the radio unit 22 not to stop transmitting the packet signal and to continue transmitting the signal when the information about whether the vehicle 12 is present in any of the areas 200 indicates the presence even when the information about whether the vehicle 12 travels or stops indicates the stop of the vehicle 12. Meanwhile, the instructing unit 48 may decrease transmission frequency of the packet signal instead of allowing the radio unit 22 to stop transmitting the packet signal. In this case, it is supposed that the packet signal is periodically transmitted.

Meanwhile, this radio apparatus 14 may be carried by a pedestrian instead of being mounted on the vehicle 12. In this case, the radio apparatus 14 is provided with an interface not illustrated and accepts an instruction by a user about whether this is in a mode to be mounted on the vehicle 12 or a mode to be carried by the pedestrian by means of the interface. Herein, the user corresponds to the driver or the pedestrian. The generating unit 32 includes information about whether it is in the mode to be mounted on the vehicle 12 or the mode to be carried by the pedestrian (hereinafter, referred to as “operation mode control information”) in the packed signal. For example, in the mode to be mounted on the vehicle 12, the generating unit 32 sets a bit value corresponding to the operation mode control information to “1” and in the mode to be carried by the pedestrian, the generating unit 32 sets the bit value corresponding to the operation mode control information to “0”. The notifying unit 46 may change a method of notifying the approach according to the mode set for this radio apparatus 14. For example, when this radio apparatus 14 is mounted on the vehicle 12, the notifying unit 46 notifies the approach by display on a screen and an output of a sound. On the other hand, when this radio apparatus 14 is carried by the pedestrian, the notifying unit 46 notifies the approach by the output of the sound and vibration. The control unit 28 controls timing of an entire radio apparatus 14.

Although this configuration may be realized by a CPU, a memory, and another LSI of an optional computer in a hardware aspect and is realized by a program loaded on the memory and the like in a software aspect, a functional block realized by combination of them is herein described. Therefore, one skilled in the art may comprehend that the functional block may be realized in various modes only by hardware, or only by software, or combination of them.

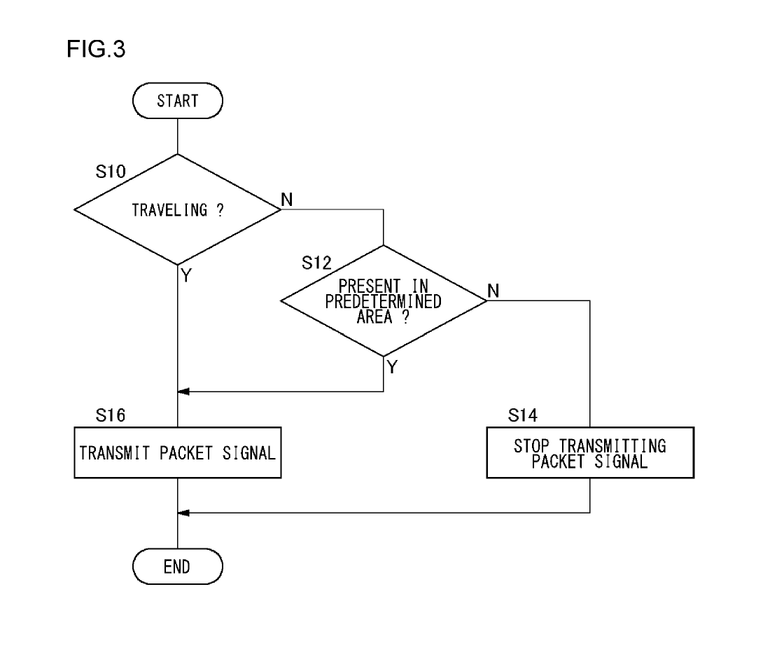

Operation of the radio apparatus 14 by the above-described configuration is described. FIG. 3 is a flowchart illustrating a procedure of the transmission process by the radio apparatus 14. When the vehicle 12 is not traveling (N at S10) and is not present in a predetermined area 200 (N at S12), the instructing unit 48 allows the radio unit 22 to stop transmitting the packet signal (S14). On the other hand, when the vehicle 12 is present in the predetermined area 200 (Y at S12), the instructing unit 48 allows the radio unit 22 to transmit the packet signal (S16). When the vehicle 12 is traveling (Y at S10), the instructing unit 48 allows the radio unit 22 to transmit the packet signal (S16).

Next, a modification of the present invention is described. The modification of the present invention relates to the communication system, which executes the data communication between the radio apparatuses mounted on the vehicles, as in the embodiment. Also, as in the embodiment, the radio apparatus according to the modification continues transmitting the packet signal when the vehicle travels and stops transmitting the packet signal when the vehicle stops. In the radio apparatus according to the modification, a criterion to transmit the packet signal also when the vehicle stops is determined so as to be different from that in the embodiment. The radio apparatus according to the embodiment continues transmitting the packet signal when this is present in the predetermined area such as in the vicinity of the intersection. On the other hand, the radio apparatus according to the modification continues transmitting the packet signal when a direction indicator and a hazard switch operate. In such a case, it is supposed that the vehicle stops for turning right or left in a short time or temporarily stops, so that the packet signal should be continuously transmitted.

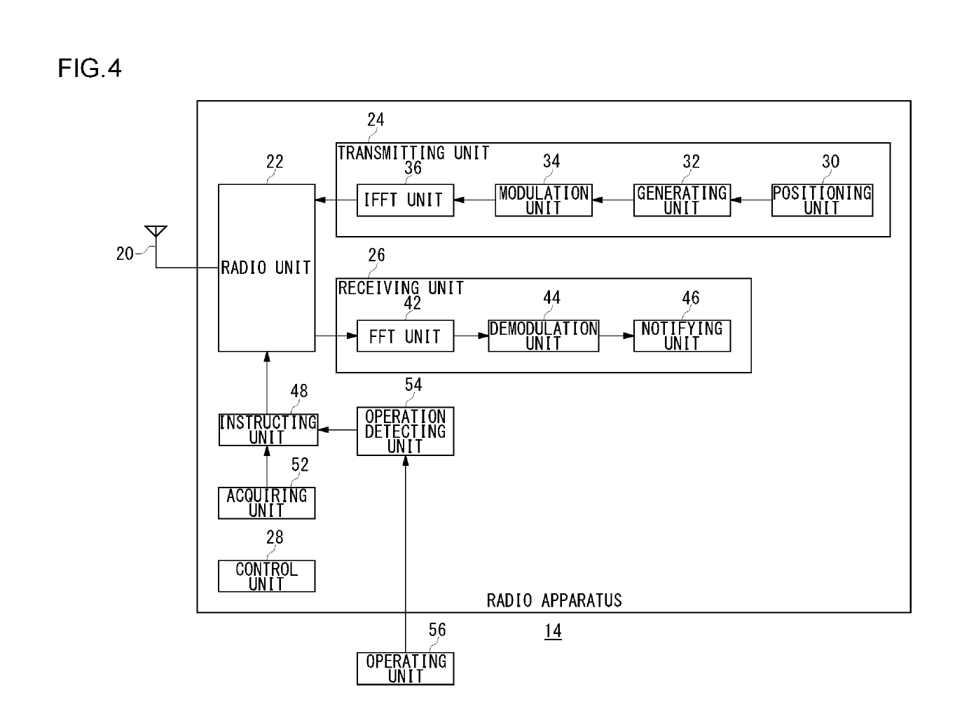

Although the communication system 100 according to the modification is illustrated as in FIG. 1, the area 200 is omitted. FIG. 4 illustrates the configuration of the radio apparatus 14 according to the modification of the present invention. As compared to the radio apparatus 14 in FIG. 2, the radio apparatus 14 does not include the position detecting unit 50 but includes an operation detecting unit 54. Also, the radio apparatus 14 is connected to an operating unit 56. In FIG. 4, components indicated by the same reference signs as in FIG. 2 execute the process similar to the process in FIG. 2. Therefore, difference from FIG. 2 is herein mainly described.

The operating unit 56 is a button and the like for operating the vehicle 12 on which this radio apparatus 14 is mounted. The operating unit 56 corresponds to the direction indicator and the hazard switch, for example. When the direction indicator and the hazard switch are operated by the driver, the vehicle 12 executes original operation corresponding to them. That is to say, when the direction indicator is operated, one of lights mounted on right and left sides of the vehicle 12 blinks. When such operation is performed by the driver, the operating unit 56 outputs the fact to the operation detecting unit 54.

The operation detecting unit 54 is connected to the operating unit 56 for detecting whether the operating unit 56 is operated. When the operation is detected, the operation detecting unit 54 outputs the fact to the instructing unit 48. The instructing unit 48 accepts the information about whether the vehicle 12 travels or stops from the acquiring unit 52 and accepts the information that the operation of the operating unit 56 is detected from the operation detecting unit 54. When the operation detecting unit 54 detects the operation, the instructing unit 48 allows the radio unit 22 to continue transmitting the packet signal without stopping also when the information acquired by the acquiring unit 52 indicates the stop of the vehicle 12.

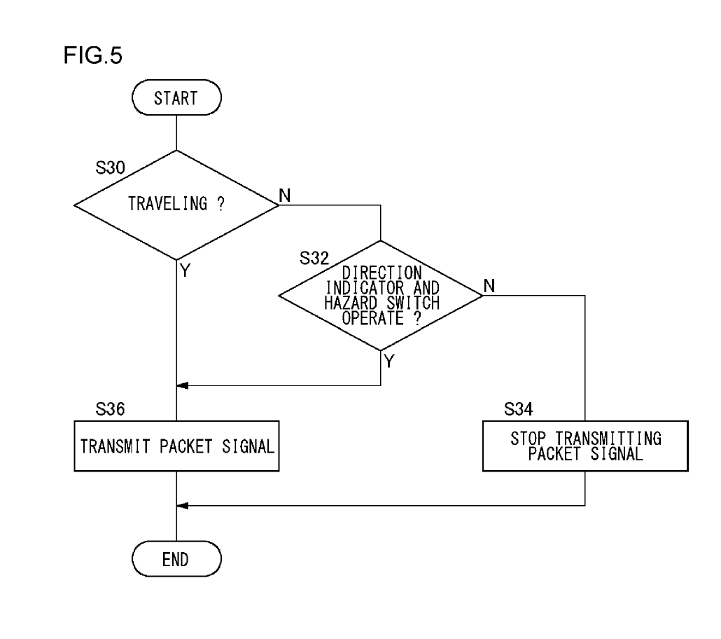

FIG. 5 is a flowchart illustrating the procedure of the transmission process by the radio apparatus 14. When the vehicle 12 is not traveling (N at S30) and the direction indicator and the hazard switch are not operated (N at S32), the instructing unit 48 allows the radio unit 22 to stop transmitting the packet signal (S34). On the other hand, when the direction indicator and the hazard switch are operated (Y at S32), the instructing unit 48 allows the radio unit 22 to transmit the packet signal (S36). When the vehicle 12 is traveling (Y at S30), the instructing unit 48 allows the radio unit 22 to transmit the packet signal (S36).

Next, another modification of the present invention is described. Another modification of the present invention also relates to the communication system, which executes the data communication between the radio apparatuses mounted on the vehicles, as in the above-described cases. Also, the radio apparatus according to the modification continues transmitting the packet signal when the vehicle travels and stops transmitting the packet signal when the vehicle stops. In the radio apparatus according to another modification, the criterion to transmit the packet signal also when the vehicle stops is determined so as to be different from that described above. The radio apparatus according to another modification continues transmitting the packet signal when another vehicle is present behind the vehicle on which the radio apparatus is mounted. In such a case, it is supposed that the vehicle temporarily stops due to traffic jam and the like, so that the transmission of the packet signal should be continued.

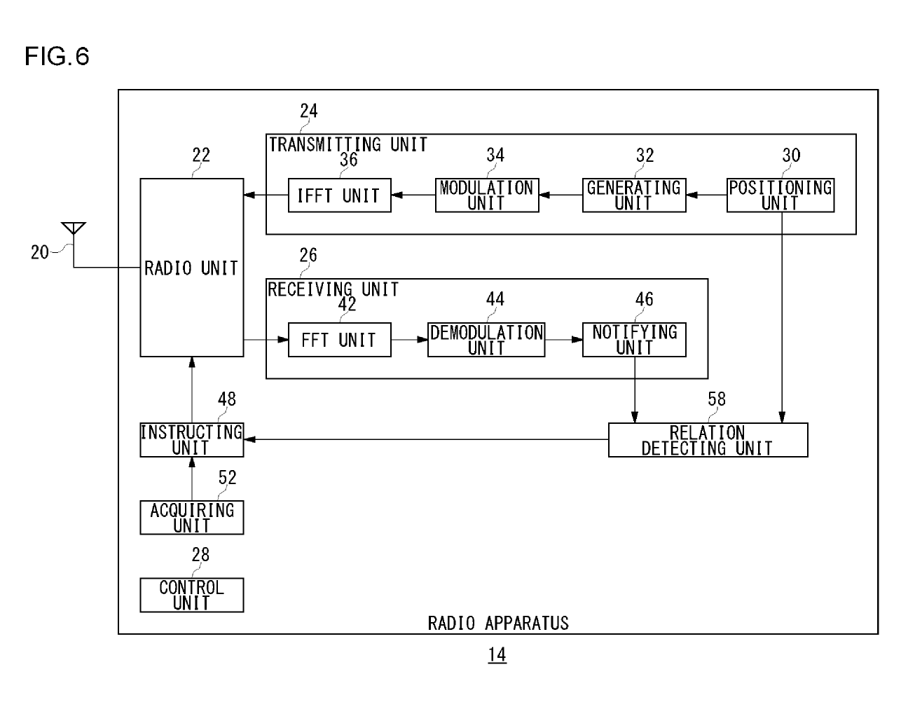

FIG. 6 illustrates the configuration of the radio apparatus 14 according to another modification of the present invention. As compared to the radio apparatus 14 in FIG. 2, the radio apparatus 14 does not include the position detecting unit 50 but includes a relation detecting unit 58. In FIG. 6, components indicated by the same reference signs as in FIG. 2 execute the process similar to the process in FIG. 2. Therefore, the difference from FIG. 2 is herein mainly described.

The relation detecting unit 58 accepts the positional information of the vehicle 12 on which this radio apparatus 14 is mounted from the positioning unit 30. The relation detecting unit 58 also accepts the information about the position of another vehicle 12 from the notifying unit 46. Based on history of the positional information of the vehicle 12 on which this radio apparatus 14 is mounted, the relation detecting unit 58 specifies the travel direction and a current position of the vehicle 12 in question. Also, based on the information about the position of another vehicle 12, the relation detecting unit 58 specifies the travel direction and the current position of another vehicle 12. Further, based on the travel direction and the current position of the vehicle 12 in question and the travel direction and the current position of another vehicle 12, the relation detecting unit 58 detects whether another vehicle 12 is present behind the vehicle 12 in question. The relation detecting unit 58 outputs the information about whether another vehicle 12 is present behind the vehicle 12 in question to the instructing unit 48.

The instructing unit 48 accepts the information about whether the vehicle 12 travels or stops from the acquiring unit 52 and accepts the information about whether another vehicle 12 is present behind the vehicle 12 from the relation detecting unit 58. When the relation detecting unit 58 detects the presence, the instructing unit 48 allows the radio unit 22 to continue transmitting the packet signal without stopping also when the information acquired by the acquiring unit 52 indicates the stop of the vehicle 12.

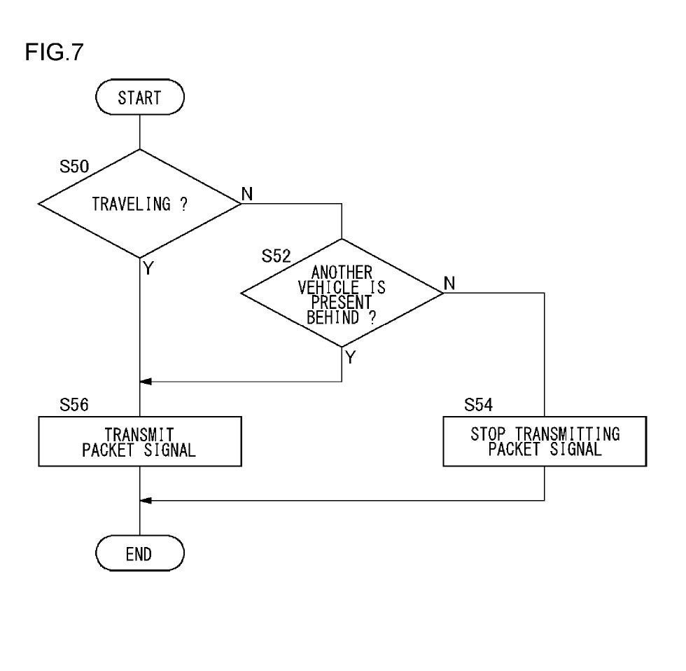

FIG. 7 is a flowchart illustrating the procedure of the transmission process by the radio apparatus 14. When the vehicle 12 is not traveling (N at S50) and another vehicle 12 is not present behind the same (N at S52), the instructing unit 48 allows the radio unit 22 to stop transmitting the packet signal (S54). On the other hand, when another vehicle 12 is present behind (Y at S52), the instructing unit 48 allows the radio unit 22 to transmit the packet signal (S56). When the vehicle 12 is traveling (Y at S50), the instructing unit 48 allows the radio unit 22 to transmit the packet signal (S56).

Next, still another modification of the present invention is described. The radio apparatus described above is for that mounted on the vehicle or carried by the pedestrian. On the other hand, the radio apparatus according to still another modification is for that carried by the pedestrian. When the radio apparatus is mounted on the vehicle, if the vehicle stops, the radio apparatus stops transmitting the packet signal. On the other hand, possibility of traffic accident of the pedestrian is not low also when the pedestrian stops, it is desired that the radio apparatus carried by the pedestrian who transmits the packet signal, thereby notifying the radio apparatus mounted on the vehicle of the presence. In such a case also, in order to inhibit the traffic of the packet signal to decrease the collision probability of the packet signals, the radio apparatus according to still another modification executes the following process.

When the radio apparatus receives the packet signal from another radio apparatus, this measures reception strength of the packet signal in question and confirms the operation mode control information. When the packet signal is such that the operation mode control information indicates the mode to be carried by the pedestrian and the reception strength is larger than the threshold, the radio apparatus increments a counter. When a counter value becomes a predetermined value or larger in a unit period, the radio apparatus decreases the transmission frequency of the packet signal.

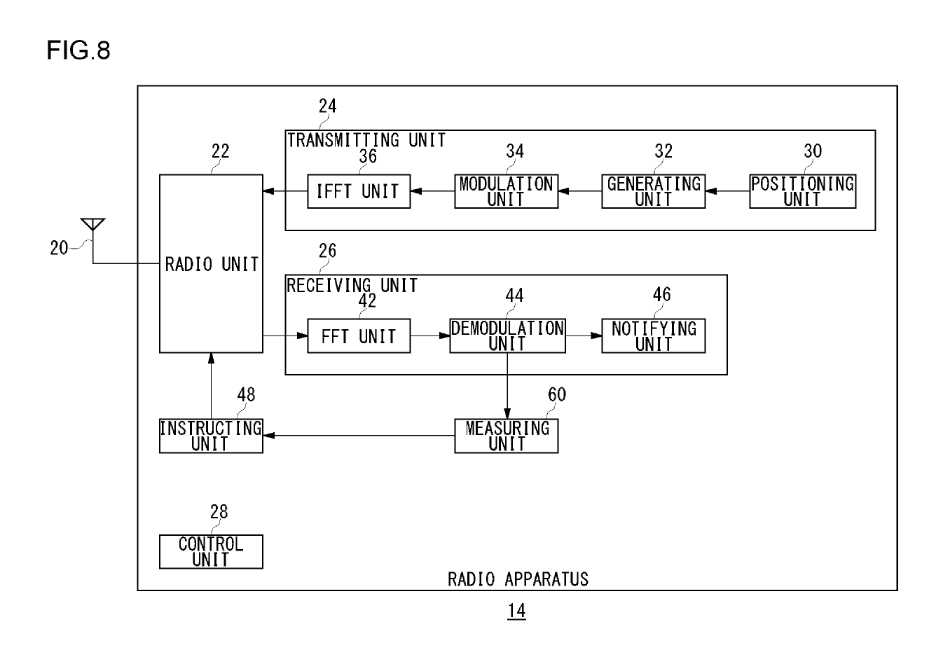

FIG. 8 illustrates the configuration of the radio apparatus 14 according to still another modification of the present invention. As compared to the radio apparatus 14 in FIG. 2, the radio apparatus 14 does not include the position detecting unit 50 and the acquiring unit 52 but includes a measuring unit 60. In FIG. 8, components indicated by the same reference signs as in FIG. 2 execute the process similar to the process in FIG. 2. Therefore, difference from FIG. 2 is herein mainly described.

As described above, the demodulation unit 44 demodulates the packet signal from another radio apparatus. The demodulation unit 44 extracts the operation mode control information from the packet signal. Also, the demodulation unit 44 measures the reception strength of the packet signal. The demodulation unit 44 outputs combination of the operation mode control information and the reception strength to the measuring unit 60. The measuring unit 60 is provided with the counter. When the operation mode control information indicates the mode to be carried by the pedestrian and the reception strength is larger than the threshold, the measuring unit 60 increments the counter. The process is performed each time the combination is accepted. When the counter value becomes the predetermined value or larger in the unit period, the fact is output to the instructing unit 48. Meanwhile, the demodulation unit 44 resets the counter value when a predetermined period has passed. Also, when the counter value becomes smaller than the predetermined value in the unit period, the fact may be output to the instructing unit 48.

When the instructing unit 48 is notified that the counter value becomes the predetermined value or larger in the unit period, this allows the radio unit 22 to decrease the transmission frequency of the packet signal. Herein, it is also possible to stop the transmission of the packet signal instead of decreasing the transmission frequency of the packet signal. Meanwhile, under a situation in which the transmission frequency of the packet signal is decreased, when the instructing unit 48 is notified that the counter value becomes smaller than the predetermined value in the unit period, this may increase the transmission frequency of the packet signal.

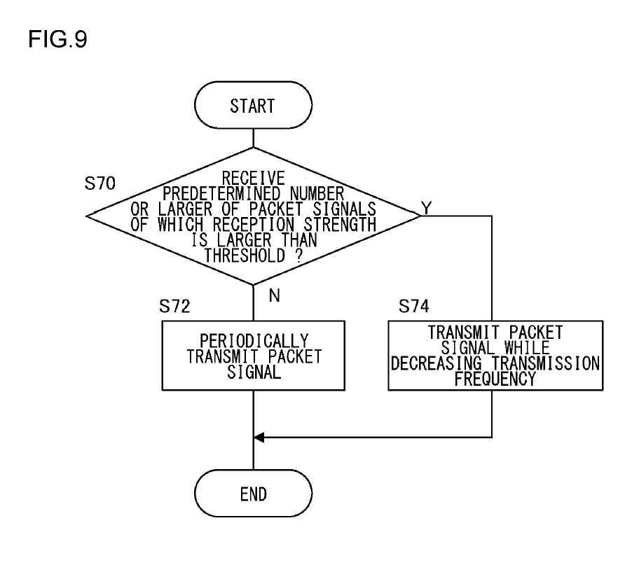

FIG. 9 is a flowchart illustrating the procedure of the transmission process by the radio apparatus 14. In a case in which a predetermined number or larger of the packet signals of which reception strength is larger than the threshold are not received from another radio apparatus 14 carried by the pedestrian (N at S70), the instructing unit 48 allows the radio unit 22 to periodically transmit the packet signal (S72). In a case in which the predetermined number or larger of the packet signals of which reception strength is larger than the threshold are received from another radio apparatus 14 carried by the pedestrian (Y at S70), the instructing unit 48 allows the radio unit 22 to transmit the packet signal while decreasing the transmission frequency thereof (S74).

According to the embodiment of the present invention, when the vehicle travels, the packet signal including the positional information and the like is transmitted, so that it is possible to notify the driver of another vehicle of the approach. Also, since the packet signal including the positional information and the like is received from the radio apparatus mounted on the traveling vehicle, it is possible to notify the driver of the approach. Also, since the driver is notified of the approach, generation of the collision accident may be decreased. Also, when the vehicle stops, the transmission of the packet signal is stopped, so that the traffic amount may be decreased. Also, since the traffic amount is decreased, the collision probability of the packet signals may be decreased. Also, since the collision probability of the packet signals is decreased, the required packet signal may be surely transmitted.

When the vehicle stops also, if this is present in the predetermined area, the packet signal is continuously transmitted, so that it is possible to notify the presence when this stops at the intersection and the like. Also, since the presence is notified when this stops at the intersection and the like, it is possible to notify the necessary information while decreasing the traffic amount. When the vehicle stops also, the packet signal is continuously transmitted when the direction indicator and the hazard switch are operated, so that it is possible to notify the presence when this temporarily stops. Also, the presence is notified when this temporarily stops, so that it is possible to notify the necessary information while decreasing the traffic amount. When the vehicle stops also, the packet signal is continuously transmitted if another vehicle is present behind the same, so that it is possible to notify the presence when this stops due to the traffic jam. Also, the presence is notified when this stops due to the traffic jam, so that it is possible to notify the necessary information while decreasing the traffic amount.

Also, since the degree of reception of the packet signal of which reception strength is large is observed, it is possible to estimate whether the radio apparatus is present nearby. Also, since the transmission frequency is decreased when the large number of packet signals of which reception strength is large are received, it is possible to decrease the transmission frequency when the pedestrian is present nearby. Also, since the transmission frequency is decreased when the pedestrian is present nearby, it is possible to notify the presence without transmitting the packet signal. Also, since the transmission frequency is decreased when the pedestrian is present nearby, it is possible to decrease the collision probability of the packet signals.

The present invention is described above based on the embodiment. The embodiment is illustrative only and one skilled in the art may comprehend that various modifications of combination of the components and the processes are possible and such modifications are also included within the scope of the present invention.

In the embodiment of the present invention, the instructing unit 48 continues transmitting the packet signal when a predetermined condition is satisfied also when the vehicle 12 stops. However, this is not limitation, and the instructing unit 48 may stop the transmission of the packet signal without determining the predetermined condition when the vehicle 12 stops, for example. According to the modification, the process may be made easy.

What is claimed is:

1. A radio apparatus, comprising:
a transmitting unit configured to transmit a packet signal;
an acquiring unit configured to acquire information about a traveling status of a vehicle; and
an instructing unit configured to allow the transmitting unit to decrease transmission frequency of the packet signal when the information acquired by the acquiring unit indicates a stop of the vehicle.

2. The radio apparatus according to claim 1, wherein the instructing unit allows the transmitting unit to stop transmitting the packet signal so as to decrease the transmission frequency of the packet signal.

3. The radio apparatus according to claim 1, further comprising an operation detecting unit configured to detect whether an operating unit of the vehicle on which this radio apparatus is mounted is operated, wherein
when the operation detecting unit detects operation, the instructing unit allows the transmitting unit to continue transmitting the packet signal even when the information acquired by the acquiring unit indicates the stop of the vehicle.

4. The radio apparatus according to claim 1, further comprising a position detecting unit configured to detect whether the vehicle is present in a predetermined area based on positional information of the vehicle, wherein
when the position detecting unit detects presence, the instructing unit allows the transmitting unit to continue transmitting the packet signal even when the information acquired by the acquiring unit indicates the stop of the vehicle.

5. The radio apparatus according to claim 1, further comprising a relation detecting unit configured to detect whether another vehicle is present behind the vehicle on which this radio apparatus is mounted, wherein
when the relation detecting unit detects the presence, the instructing unit allows the transmitting unit to continue transmitting the packet signal even when the information acquired by the acquiring unit indicates the stop of the vehicle.

6. A radio apparatus, comprising:
a transmitting unit configured to transmit a packet signal;
a receiving unit configured to receive the packet signal from another radio apparatus; and
an instructing unit configured to allow the transmitting unit to decrease transmission frequency of the packet signal when the receiving unit receives a predetermined number or larger of packet signals of which reception strength is larger than a threshold in a unit period.
